(19) United States
(12) Patent Application Publication
(10) Pub. No.: US 2007/0171090 A1
(43) Pub. Date: Jul. 26, 2007

(54) WEARABLE IMAGING DEVICE

(75) Inventors: Yona Newman, Ra'Anana (IL); Shmuel Barman, Modi'in, Makabin-Re'Ut (IL); Jacob Gabay, Rosh-Ha'Ayin (IL); Avi Zelig, Rosh-Ha'Ayin (IL)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Schaumburg, IL (US)

(21) Appl. No.: 11/688,614

(22) Filed: Mar. 20, 2007

(30) Foreign Application Priority Data
Sep. 30, 2004 (GB) GB0421652.9

(51) Int. Cl. G09F 9/33; G06K 7/00; G08B 13/14

(52) U.S. Cl. 340/815.45; 340/572.8; 235/439

(57) ABSTRACT

A wearable imager device comprises an imager body 9, a strap 27 attached to the imager body 9 and adapted to be fitted to and worn by a hand or finger of a user and an indicator light 29 to indicate an operation function of the device 21, wherein the indicator light 29 is incorporated in the strap 27. The strap 27 is conveniently made of a flexible material. The indicator light 29 may comprise a flexible light emitting band formed in the strap 27 in part or substantially all of the length of the strap 27.

### FIELD OF THE INVENTION

This invention relates to a wearable imaging device, particularly a data collection and communication device.

### BACKGROUND IF THE INVENTION

Wearable devices are increasingly being used for a range of functions involving data collection and communication. Such devices are being used for example in bar code or image capture, identification and verification, and in services such as parcel location and tracking which include transmission of data relating to the captured information. Such devices can be worn by a user on one or more fingers of the hand, on the front or back of the palm, on the wrist or on the forearm.

These devices normally are made as small and light as possible and communicate by short range wireless links such as Bluetooth, for example to a receiver carried by the user, e.g. on a larger belt, or for example to a nearby terminal such as a desk mounted computing unit which may have a keyboard and display for user entry and display of information.

A simple known wearable device, for example for capturing and communicating data relating to bar codes or still images, consists of a housing or body containing: a lens, an optical imager such as an imager chip, a microprocessor, a short range radio transmitter an antenna and a battery. Also usually incorporated in the body is an indicator light such as a LED (Light Emitting Diode) which is used to indicate successful bar code or image capture and/or data transmission. The housing or body may include a user wearable strap, e.g. designed to go around and be carried by two fingers of the user.

For ergonomic reasons it is desirable to reduce, as far as possible, the weight of the housing or body and its components in a device of the kind described. This is because for a such a device the weight of the housing and components acts through the device centre of gravity and the distance to the centre of the finger straps, forms a leverage force. Over a typical operator working shift of say 8 to 10 hours, such forces can cause operator fatigue, and in the long term, RSI (Repetitive Strain Injury).

Also the position of the indicator light must be carefully chosen to ensure that in all modes of use, it is still readily viewable, and this requirement may necessitate the use of multiple lights, such as LEDs, with greater energy consumption, thus further adding to the weight.

The purpose of the present invention is to provide a user wearable imaging device such as a data collection and communication device in which the above disadvantages are reduced.

### SUMMARY OF INVENTION

In accordance with the present invention there is provided a wearable imager device according to claim 1.

The device may for example be a data collection and communication device.

Embodiments of the present invention will now be described by way of example with reference to the accompanying drawings, in which:

### BRIEF DESCRIPTION OF THE DRAWINGS

FIG. 1 is a perspective view of a known wearable imager device.

FIG. 2 is a perspective view of a wearable imager device embodying the invention.

### DESCRIPTION OF SPECIFIC EMBODIMENTS OF THE INVENTION

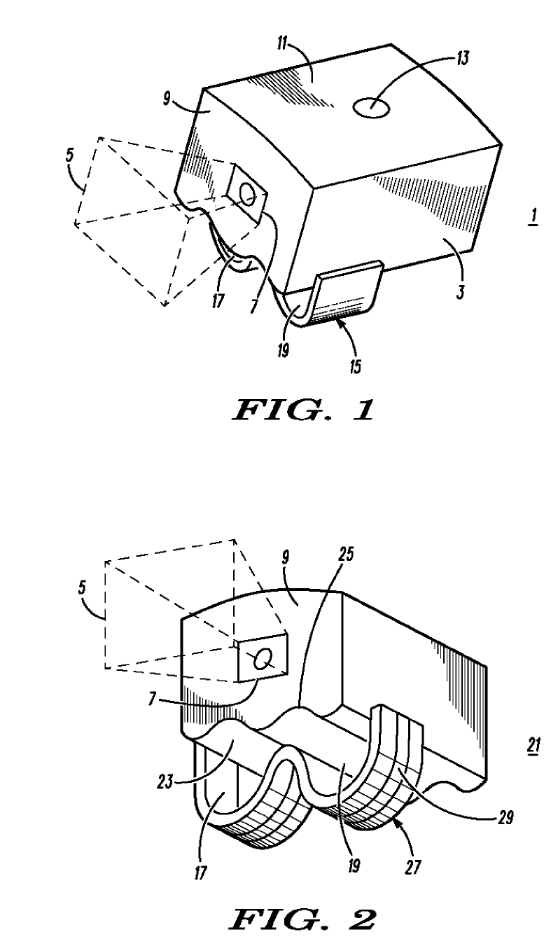

FIG. 1 is a perspective view of a known wearable imager device 1 for capturing an optical (visible or infra-red) image of an object of interest, e.g. a package or product bearing a bar code to be read). The device has a body 3 incorporating (not shown) an optical scanner and reader device, electronic processing circuitry and a RF transmitter for sending information relating to the captured image to a another terminal (e.g. in a unit carried by the user or held elsewhere). Radiation emitted by the optical scanner is indicated as a beam 5 which is issued through a window/lens unit 7 in a front face 9 of the body 3. A top face 11 incorporates a LED indicator 13 to light to indicate correct operation of the scanning and reading of an image. The body 3 and its contents are carried by a user by support on a strap 15. The strap 15 is bent to form two slots 17 and 19 through which two fingers (not shown) of a user are passed and so that the body is held supported on the user's fingers.

FIG. 2 is a perspective view of a wearable imager device 21 embodying the invention. Parts of the device 21 shown with the same reference numerals as those in FIG. 1 have the same function. In FIG. 2, two curved recesses 23, 25 formed in the underside of the body 3 to facilitate accommodation of the user's fingers between the body 3 and the strap 15 are shown more clearly (they are also present in the device of FIG. 1). In the device 21 there is no LED indicator in the body 3 of the device. Instead the strap 15 is replaced by a similarly shaped strap 27. The strap 27 incorporates a flexible band 29 which serves as a light indicator. The band 29 may be a flexible strip formed of LEDs. The band 29 has connections (not shown) to a battery (not shown) inside the body 3.

Other light sources incorporated in a flexible material can be used instead of LEDs, e.g. based on known light emitting technologies such as EL (Electro-Luminescent, OLED (Organic LED), and lasing fibres.

Further, several different colour sources can be used, either alongside each other, or twisted together, to give a number of different colour indications, e,g to indicate different operational indications relating to the device 21.

Further, the above light sources can be fabricated together in one piece in the strap material or woven together with the strap material, e.g. where of a fibrous material, such that they form both the strap and the light indicator in an integral, flexible structure.

The embodiment shown in FIG. 2 is for a finger mounted device, but the same principle can equally be applied to wrist, palm and forearm straps by which an imager device is to be carried.

The device shown in FIG. 2 and the alternative embodiments of the invention can show one or more of the following benefits:

(i) There are reduced leverage forces on the finger or hand of the user, so there is a reduced risk of RSI and a more comfortable working shift.

(ii) Since the whole length of the strap (or a major portion of its length) can be used to provide the light indicator, there is little chance of the user missing the indication.

(iii) Better sealing of the device body 3 can be provided as no hole or window is required for the LED indicator as in FIG. 1. This also provides a more robust housing.

(iv) A strip of light may be considered to be more user friendly and easier on the eyes of the user compared to a spot light source.

(v) A lower level of illumination energy can be used because it is over a large area, so saving energy and potential allowing battery weight and size to be reduced.

1. A wearable imager device comprising an imager body, a strap attached to the imager body and adapted to be fitted to and worn by a hand or finger of a user and an indicator light to indicate an operation function of the device, wherein the indicator light is incorporated in the strap.

2. A device according to claim 1 wherein the strap is made of a flexible material.

3. A device according to claim 1 wherein the indicator light comprises a flexible light emitting band formed in the strap in part or substantially all of the length of the strap.

4. A device according to claim 1 wherein the indicator light is formed of one or more of: one or more light emitting diodes (LED); one or more electroluminescent devices; one or more organic light emitting diodes (LED); and one or more lasing fibres or filaments.

5. A device according to claim 1 wherein the indicator light emits light in different colours.

6. A device according to claim 1 wherein the indicator light comprises flexible material which is incorporated in a woven structure.

7. A device according to claim 6 wherein the woven structure includes strap material.
